(19) United States
(12) Patent Application Publication
(10) Pub. No.: US 2016/0069364 A1
(43) Pub. Date: Mar. 10, 2016

(54) CAPTURED FASTENER DEVICE

(71) Applicant: Parker-Hannifin Corporation, Cleveland, OH (US)

(72) Inventors: Kyle M. Montague, Avon, NY (US); John H. Beswick, Williamson, NY (US); Jeffrey P. White, North Rose, NY (US)

(21) Appl. No.: 14/848,756

(22) Filed: Sep. 9, 2015

Related U.S. Application Data
(60) Provisional application No. 62/048,077, filed on Sep. 9, 2014.

(51) Int. Cl. F16B 2/06; F16B 39/00

(52) U.S. Cl. CPC F16B 2/06; F16B 39/00

(57) ABSTRACT

Provided is at least one finger that allows securing of various sizes of bolts, undersized or oversized. Flow channels in a compression limiter allow plastic to flow from an outer portion of the compression limiter to a center of the compression limiter to form the angled fingers. The angled fingers allow cheaper manufacture of the compression limiter. The length of the compression limiter may be manufactured using lower tolerances. Also, the inner diameter of the compression limiter does not need an angled step to or tight tolerances, which allows less costly manufacturing of the compression limiter.

### RELATED APPLICATIONS

This application claims the benefit of U.S. Provisional Application No. 62/048,077 filed Sep. 9, 2014, which is hereby incorporated herein by reference.

### FIELD OF INVENTION

The present invention relates generally to assemblies, and more particularly to a captured fastener apparatus and a method of making the same.

### BACKGROUND

Articles having bolt-receiving openings have been used in assemblies for various purposes. Frequently the articles are fastened to other objects or articles by using a nut and a bolt or other metal threaded fastener. Typically, bolts are pre-assembled into a bolt hole in the articles to facilitate bolting the articles to the other objects or articles. A tubular thermoplastic retainer, such as an AXI-RAD®, is often installed on the bolts (or other threaded fastener) and inserted into a compression limiter (e.g., a metal compression limiter) of the articles to secure the bolts to the articles and maintain alignment prior to assembly.

Typically, the compression limiter is pressed into a bore in the articles and receives the tubular thermoplastic retainer and the bolt. The compression limiter strengthens the article (particularly when formed from plastic) and resists the load that is applied thereto. The integrity of the article, therefore, is not compromised. Additionally, the compression limiter prevents/reduces material creep which can cause reduction of the fastener tightening torque over time.

Traditional retention mechanisms, like the tubular thermoplastic retainer designs, require multiple assembly steps and tight tolerances to match the size of a corresponding bolt (e.g., a diameter of the retention mechanism must be within ±0.005″ of a diameter of the bolt). A typical tubular thermoplastic retainer design requires inserting the compression limiter into the article, later inserting the bolt into a tubular thermoplastic retainer, and later inserting the bolt and the tubular thermoplastic retainer into the compression limiter to secure the bolt to the article. Tolerances needed to be tight for the article, compression limiter, and tubular thermoplastic retainer. Otherwise, the fastener may be unsecured and/or misalignment may occur, which can lead to added costs due to manual labor required to align the bolt, wasted defective materials, and/or delay.

### SUMMARY OF INVENTION

The present disclosure provides a captured fastener apparatus that includes at least one finger for securing various sizes of fasteners, including undersized or oversized fasteners. In forming the at least one finger, flow channels in a compression limiter allow a material, such as plastic, to flow from an outer portion of the compression limiter to a center of the compression limiter to form one or more angled fingers. The one or more angled fingers enable the compression limiter to be manufactured at a reduced cost and/or enable the compression limiter to be manufactured using lower tolerances. Also, an inner diameter of the compression limiter does not need an angled step or tight tolerances, which allows use of less costly manufacturing techniques for the compression limiter.

According to one aspect of the invention, an assembly component includes a body having a through aperture defined by an interior surface of the body for receiving the shank of a fastener, and at least one resilient finger projecting radially and axially into the aperture for engaging at a free end of the at least one finger the shank of the fastener, and wherein the free end is radially inwardly spaced from the interior surface for defining therebetween a radial gap that allows the free end to flex toward the interior surface for gripping and retaining the shank of the fastener in the aperture.

The body may include a main body portion formed of plastic and a compression limiter fixed in the body and forming the interior surface, the compression limiter being formed of a material less compressible than main body portion in a region proximate to the compression limiter.

The main body portion may be over-molded onto the compression limiter.

The body may include radially inwardly extending anchor portions connected to a base portion of the body.

The free end may be opposite a proximal end connected to the base portion of the body.

The compression limiter may have a channel in which a fixed portion of each radially inwardly extending anchor portion is accommodated.

Each finger may be unitary with the main body portion.

The base portion may be unitary with each finger.

Each finger may project radially and axially into the aperture in an unflexed state of the finger.

The at least one finger may be a plurality of fingers that are circumferentially spaced about the aperture.

The thickness of each finger may be less than a length of each finger, respectively.

A circumferential length of each finger may be greater than the thickness of each finger.

The thickness of each finger may be 5%-25% the length of each finger, respectively.

The thickness of each finger may be 10%-15% the length of each finger, respectively.

The assembly component may further include a circumferential spacing between each finger.

The circumferential length of each finger may be equal to or greater than a circumferential length of each circumferential spacing.

A component assembly including the assembly component may further include the shank of the fastener held within the aperture.

A method of securing a fastener to a body of the assembly may include inserting a fastener into the aperture, and the free end of each finger may be resiliently flexed radially and axially to apply a gripping force to the shank of the fastener.

The compression limiter may include at least one channel for connecting to each finger of the body.

The compression limiter may include a plurality of channels for connecting to each finger of the body.

The at least one resilient finger may include a radially inward extending portion.

The radially inward extending portion may circumferentially span the free end of the finger.

The foregoing and other features of the invention are hereinafter described in greater detail with reference to the accompanying drawings.

### BRIEF DESCRIPTION OF THE DRAWINGS

FIG. 1 is a perspective view of an exemplary exploded component assembly.

FIG. 2 is a perspective view of the assembly of FIG. 1, with part of the component assembly cut-away to show orientation of components.

FIG. 3 is a perspective view similar to FIG. 2, but with an enlarged view of a single fastener and with part of the component assembly cut-away at a different angle than FIG. 2.

FIG. 4 is a perspective view similar to FIG. 2, but with an enlarged view and the fastener being shown transparent to show orientation of components.

FIG. 5 is a perspective view similar to FIG. 4, but with the fastener being shown opaque.

FIG. 6a is a cross-section of the component assembly of FIG. 1 in an unflexed state.

FIG. 6b is a cross-section of the component assembly of FIG. 1 in a flexed state.

FIG. 7 is a perspective view of another exemplary component assembly with a radially inward extending portion for greater retention of a fastener, with part of the component assembly cut-away and the fastener being shown transparent.

FIG. 8 is a perspective view similar to FIG. 7, but with an enlarged view.

### DETAILED DESCRIPTION

The principles in accordance with the present disclosure have particular application to assembly components that use fasteners to fasten the assembly components to other portions of a larger assembly, such as a plastic component of a vehicle, and thus will be described below chiefly in this context. It will of course be appreciated, and also understood, that the principles in accordance with the present disclosure may be applicable to other components where it is desirable to secure a fastener to the component.

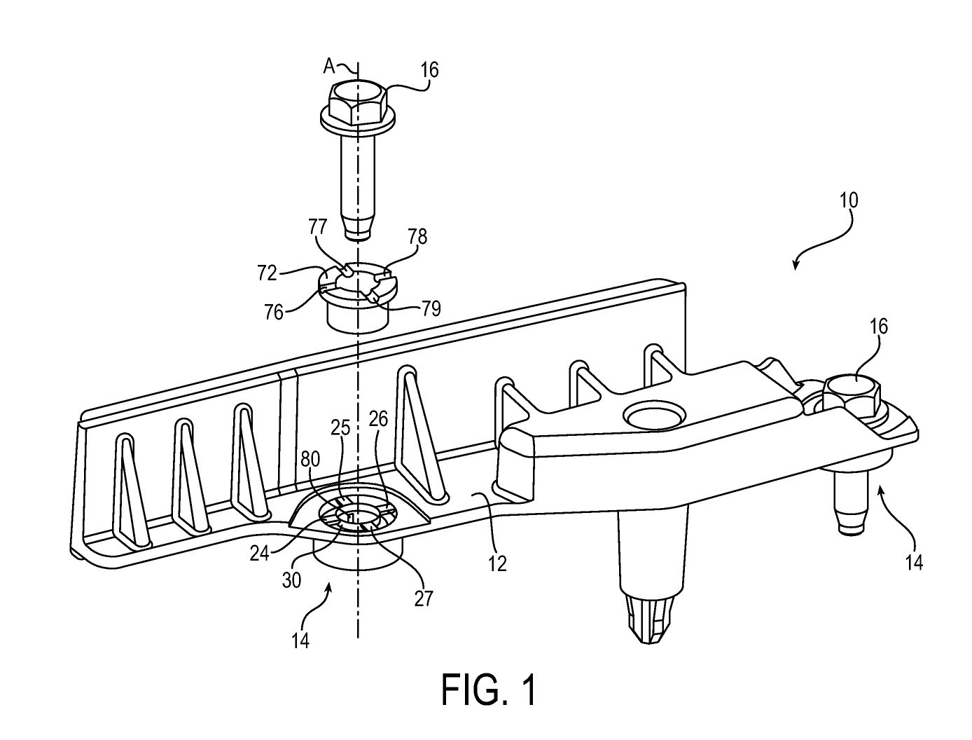

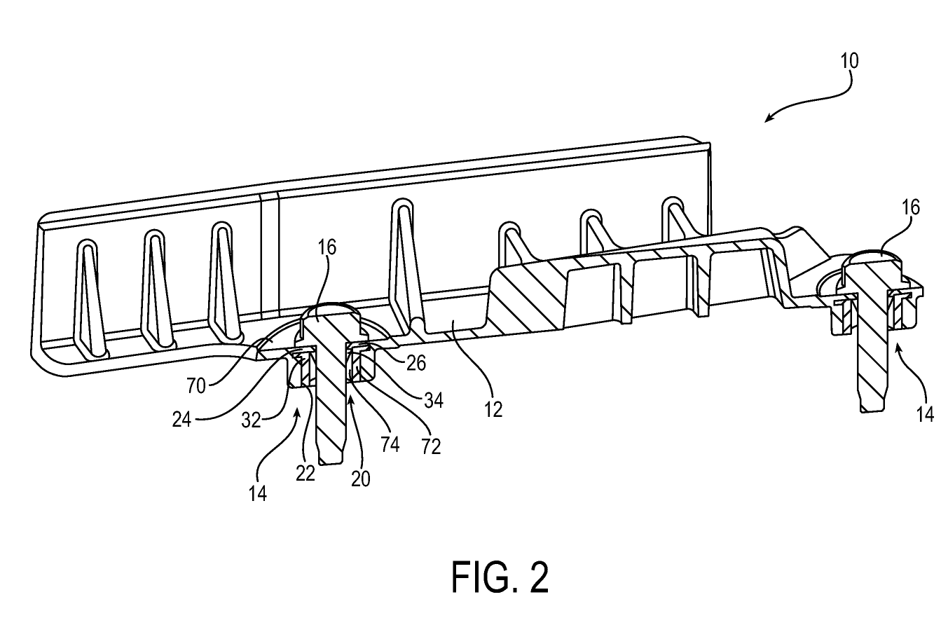

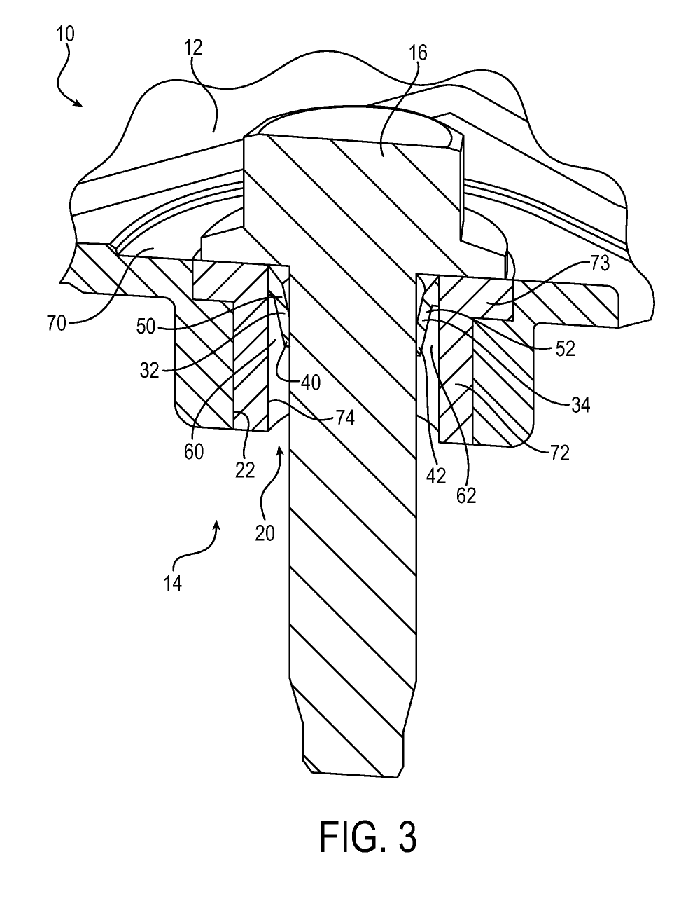

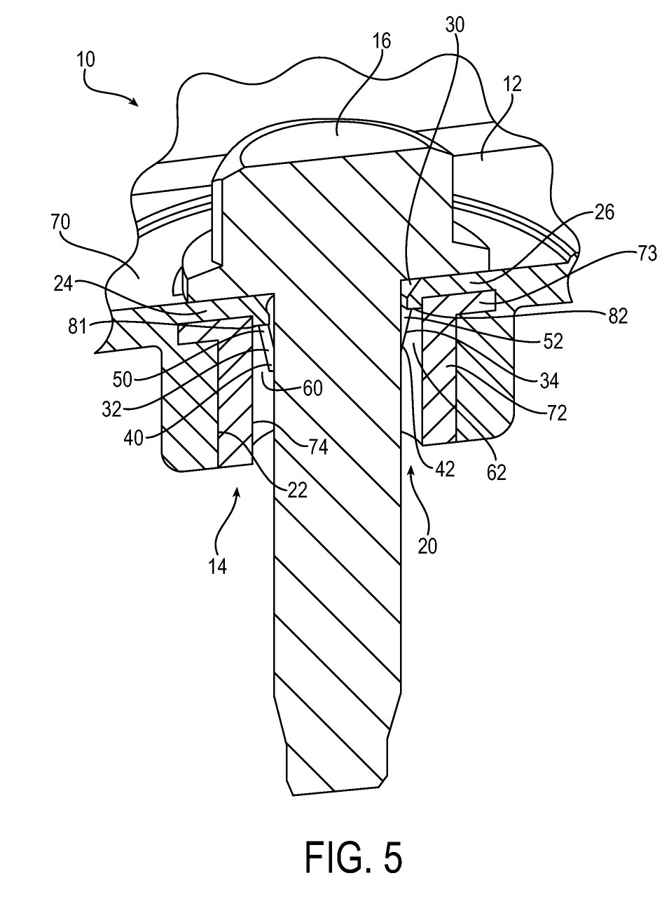

Referring now in detail to the drawings, and initially to FIGS. 1-5, a component assembly 10 is illustrated. The component assembly includes a body 12 at least partially forming a plurality of fastener mounting features 14 and a fastener 16 for each fastener mounting feature 14. The component assembly 10 may be a sub-assembly of a larger assembly (not shown) that includes the component assembly 10. The component assembly 10 is secured, such as bolted, to another component (not shown) of the larger assembly.

The component assembly 10 can be manufactured inexpensively compared to traditional component assemblies by molding the body 12 and at least part of each fastener mounting feature 14. Once the body 12 is molded, each fastener mounting feature 14 may receive the fastener 16 without any further assembly processes. Thus, the component assembly 10 requires fewer assembly steps than the prior art (e.g., neither slidably inserting a compression limiter nor slidably inserting a tubular thermoplastic retainer is required). Also, the dimensions of each fastener mounting feature 14 can be manufactured using loose tolerances compared to traditional retention systems to allow further cost reductions with cheaper manufacturing and less wasted time or materials due to an out of tolerance fastener mounting feature 14.

Each fastener mounting feature 14 includes a through aperture 20 defined by an interior surface 22 of the body 12 for receiving the shank of the fastener 16 along a longitudinal axis A, radially inwardly extending anchor portions 24-27, a base portion 30 and at least one resilient finger 32, 34 projecting radially and axially into the aperture 20. The aperture 20 allows the fastener 16 to move therethrough for the resilient fingers 32, 34 to secure and align the fastener 16 for connection with a separate component (not shown). The entire body 12 may be formed of any suitable material, such as metal or plastic, and may be formed by an injection molding process.

The radially inwardly extending anchor portions 24-27 connect to the base portion 30. The anchor portions 24-27 allow the base portion 30 to be radially inwardly spaced from the rest of the body 12 (excluding the fingers 32, 34) to form a guide surface for the fastener 16 to reach the fingers 32, 34 and a support surface for each finger 32, 34. The radially inward position of the base portion 30 allows the fingers 32, 34 to begin radially inward of the interior surface 22. The anchor portions 24-27 may be circumferentially spaced from one another to spread forces between the anchor portions 24-27. For example, in one embodiment the anchor portions 24-27 may be equi-circumferentially spaced. In another embodiment the anchor portions 24-27 may be asymmetrically circumferentially spaced. In yet another embodiment only one anchor portion may be present. In yet another embodiment the base portion 30 is not radially inwardly offset by an anchor portion.

The base portion 30 includes a circumferential portion with an axially extending ledge that each finger 32, 34 extends from. The base portion 30 may be unitary with each finger 32, 34, which allows the base portion 30 and each finger 32, 34 to be molded at the same time.

Each resilient finger 32, 34 projects radially and axially into the aperture 20 in an unflexed state of the finger 32, 34. Projecting radially and axially allows each resilient finger 32, 34 to spread radially outward due to forces caused by insertion of the fastener 16, which reduces the risk of breaking or plastically deforming a resilient finger 32, 34.

In addition to the illustrated resilient fingers 32 and 34, hidden from view in FIG. 1 are two additional fingers with similar shape and orientation. The additional fingers may be arranged opposite the resilient fingers 32 and 34 to form a generally conical boundary spaced about the aperture 20. Such additional resilient fingers may formed in the same manner and exhibit the same properties and dimensions as resilient fingers 32 and 34. In an embodiment, the fingers form a through aperture with a diameter having a tolerance between ±0.005″ and 0.025″. Preferably, the tolerance of the diameter is between ±0.010″ and 0.025″.

Each resilient finger 32, 34 is able to flex and exert a gripping force when flexed to allow the fastener 16 to be inserted and secured within the aperture 20. Securing the fastener 16 allows the fastener 16 to remain aligned relative to the body 12 for later assembly of the body 12 with another component. Each finger 32, 34 includes a free end 40, 42 opposite a proximal end 50, 52 that is connected to the base portion 30. Each free end 40, 42 engages the shank of the fastener 16 and is able to flex radially and axially to receive the shank and exert a gripping force to secure the fastener 16. For example, the shank may or may not include threaded portions of the fastener 16 and each free end 40, 42 may or may not engage the threaded portions of the shank. Alternatively, each free end 40, 42 may engage a smooth portion of the shank.

Each proximal end 50, 52 is connected to the base portion 30, preferably radially outward of the shank of the fastener 16. Each proximal end 50, 52 being radially outward of the shank allows the shank to easily pass through the aperture 20 until a portion of the shank reaches each free end 40, 42.

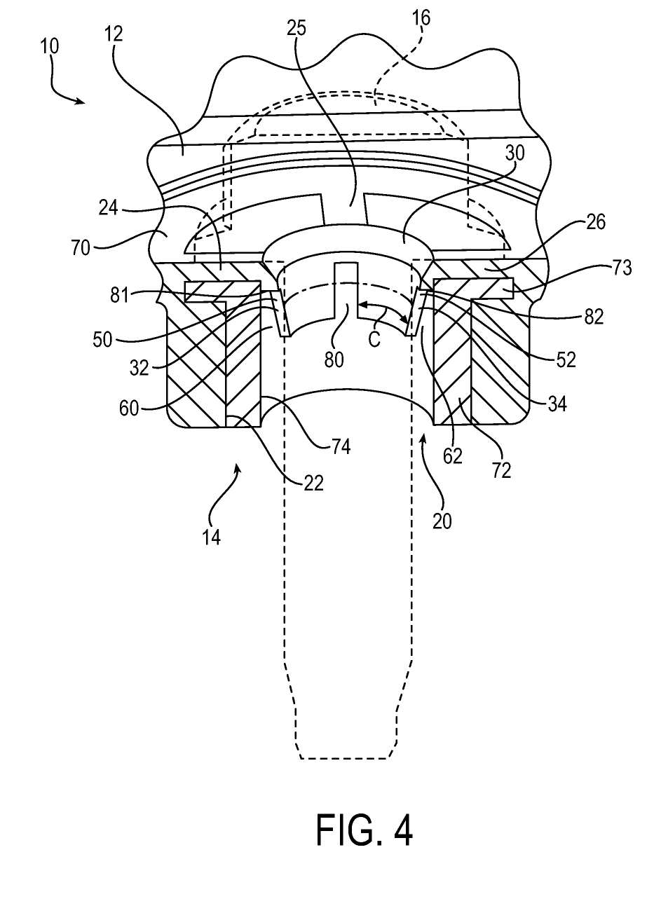

Each resilient finger 32, 34 may have a thickness less than a respective length and circumferential length, about the longitudinal axis A, of each resilient finger 32, 34. The thickness of each finger 32, 34 may be material dependent and nominal wall thickness dependent. In an embodiment, the ratio of thickness to length or circumferential length of each finger is 1:5. As used herein, the circumferential length of each finger 32, 34 is a length along arc C, illustrated in FIG. 4, about the longitudinal axis A. Forming the finger to have a thickness less than the length allows each resilient finger 32, 34 to flex and provide a gripping force to hold the shank of the fastener. In an embodiment, the thickness is between 5% and 25%, preferably between 10% and 15%, the length of each respective resilient finger. The thickness being less than the circumferential length allows each resilient finger 32, 34 to bound a larger portion of the shank of the fastener 16 to maintain alignment and increase the gripping force applied to the shank upon insertion into the aperture 20.

Each fastener mounting feature 14 may include a spacing 80-82 opening axially between adjacent radially outward portions of each resilient finger 32, 34. The spacings 80-82 allow the resilient fingers 32 and 34 to move independent of one another. The spacings 80-82 also allow greater flexibility for each resilient finger 32, 34. Preferably, the circumferential length of each resilient finger 32, 34 is greater than the circumferential length of each spacing 80-82. The greater circumferential length of each resilient finger 32, 34 enables greater gripping force to be applied to the fastener 16 and allows better alignment of the fastener 16. In an embodiment, the circumferential length of at least one resilient finger is equal to or less than at least one corresponding spacing. Each spacing 80-82 may extend axially along substantially the entire length of each respective resilient finger 32, 34. In an embodiment, at least one spacing extends less than 90% of the length of at least one resilient finger. In another embodiment, at least one spacing extends less than 25% the length of at least one resilient finger allowing a greater gripping force to be applied to hold the shank of the fastener 16.

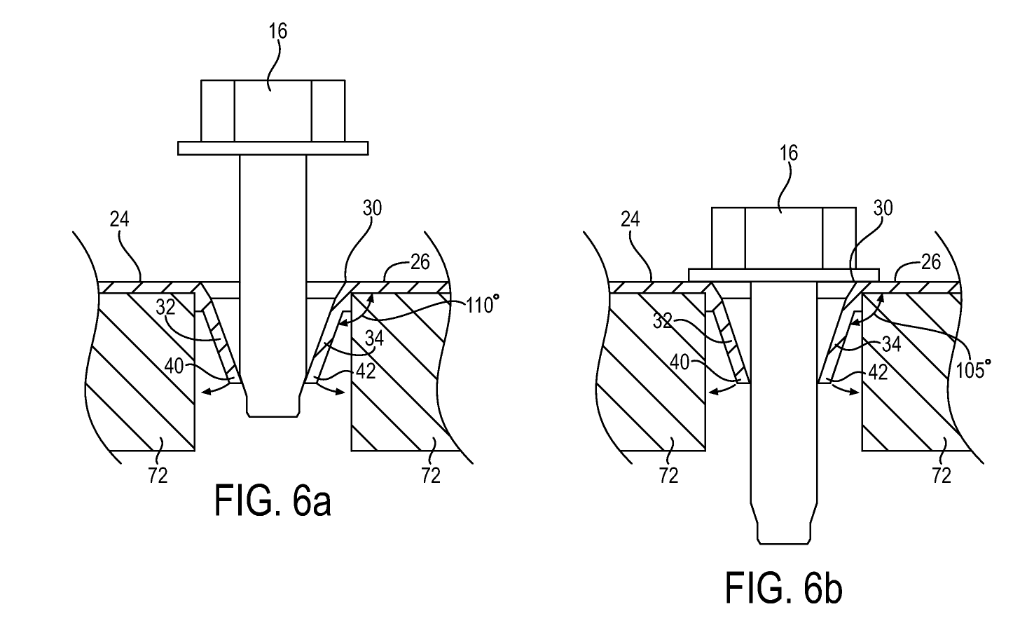

During use, the fastener 16 is inserted into the aperture 20 and each free end 40, 42 of each finger 32, 34 is resiliently flexed radially and axially to apply a gripping force to the shank of the fastener 16. The free ends 40 and 42 may move in a pivoting motion about a respective portion of each finger 32, 34 axially closer to the base portion 30. For example each free end 40, 42 may flex in an arcuate path, as shown in FIGS. 6a and 6b.

As shown in FIGS. 6a and 6b, each finger 32 and 34 is angled from the base portion 30 at approximately the same angle in an unflexed state, illustrated in FIG. 6a as 110°. As the fastener 16 slides into position between the fingers 32 and 34 in FIG. 6b, the free ends 40 and 42 flex radially and axially outward generally along the provided curved arrows. The flexing decreases the angle, illustrated for simplicity as 105°, between the base portion 30 and each finger 32, 34. Depending on the unflexed shape and orientation of each finger 32, 34, as the one or more fingers 32, 34 flex they may bow or arc between the base portion 30 and each free end 40, 42, thus acting as an unsupported end of a loaded cantilever.

Referring again to FIGS. 1-5, flexing the free ends 40 and 42 after insertion allows the fastener 16 to be secured and aligned without another assembly step. The fastener 16 may later be assembled to secure the body 12 with another component after storage, shipping, or simply repositioning to align the body 12 with the other component.

Each free end 40, 42 is radially inwardly spaced from the interior surface 22 for defining therebetween a radial gap 60, 62 that allows the free end 40, 42 to flex toward the interior surface 22 for gripping and retaining the shank of the fastener in the aperture 20. Each radial gap 60, 62 provides a space for each free end 40, 42 to flex into as the fastener 16 is inserted through the base portion 30 into the aperture 20. In an embodiment, at least one of the free ends is not provided a respective radial gap to prevent the at least one of the free ends from flexing. In another embodiment, a radial gap provides enough space for a free end to flex radially outward of the base portion 30.

Each fastener mounting feature 14 may include at least part of a main body portion 70 and a compression limiter 72. The main body portion 70 may be unitary with each finger 32, 34 such that each is made from the same molding. Molding the main body portion 70 and each finger 32, 34 together allows overmolding the compression limiter 72 to secure the compression limiter 72 and form the fingers 32, 34 in one molding step. The main body portion 70 may be formed of plastic or another moldable material to overmold and bound the compression limiter 72, which may be formed from metal. Overmolding the compression limiter allows easy manufacturing and lowers assembly time and errors that may occur with an inserted compression limiter 72.

The compression limiter 72 is fixed in the main body portion 70 with a radially outward extending ledge 73. The compression limiter forms an interior surface 74 that extends axially and circumferentially along the interior surface 22 and includes radially extending channels 76-79. Each finger 32, 34 allows the interior surface 74 to be axially linear without an interior ledge for supporting a component, such as a tubular thermoplastic retainer.

The compression limiter 72 is formed of a material less compressible than the main body portion 70 in a region proximate to the compression limiter 72. Forming the compression limiter 72 of a less compressible material, such as metal allows the compression limiter 72 to reinforce the main body portion 70, thereby providing a more secure connection between the fastener 16 and another assembly. Further, each finger 32, 34 allows the compression limiter to be made using a loose tolerance process such as molding (instead of machine turning), which allows the compression limiter 72 to be formed, for example, from powdered metal.

Each channel 76-79 is equi-circumferentially spaced to accommodate a fixed portion of each anchor portion 24-27. Accommodating the anchor portions 24-27 in such manner allows the fastener 16 to exert a gripping force axially against the compression 72 rather than a more compressible portion of the main body portion 70. Each channel 76-79 is formed in an axially facing end of the compression limiter 72, including an axially facing end of the radially outward extending ledge 73. In an embodiment, at least one of the channels is formed away from the axially facing end of the compression limiter, such as in an axially intermediate portion of the compression limiter. Alternatively, at least one of the channels may be formed at an axially facing end of the compression limiter opposite the radially outward extending ledge. During manufacturing, each channel 76-79 allows moldable material to flow over the compression limiter 72 to form the base portion 30 and the fingers 32 and 34.

An advantage of the captured fastener device in accordance with the present disclosure is that assembly time and cost of the larger assembly is reduced by using the component assembly 10, which allows inexpensively and reliably securing each fastener 16. Each fastener 16 may be secured with each fastener mounting feature 14 to properly align each fastener 16 with a corresponding fastener receiver (not shown), such as a bolt hole, of the larger assembly. Aligning each fastener 16 allows the component assembly 10 to be easily installed without requiring readjustment of one or more of the fasteners 16 to align with a respective fastener receiver.

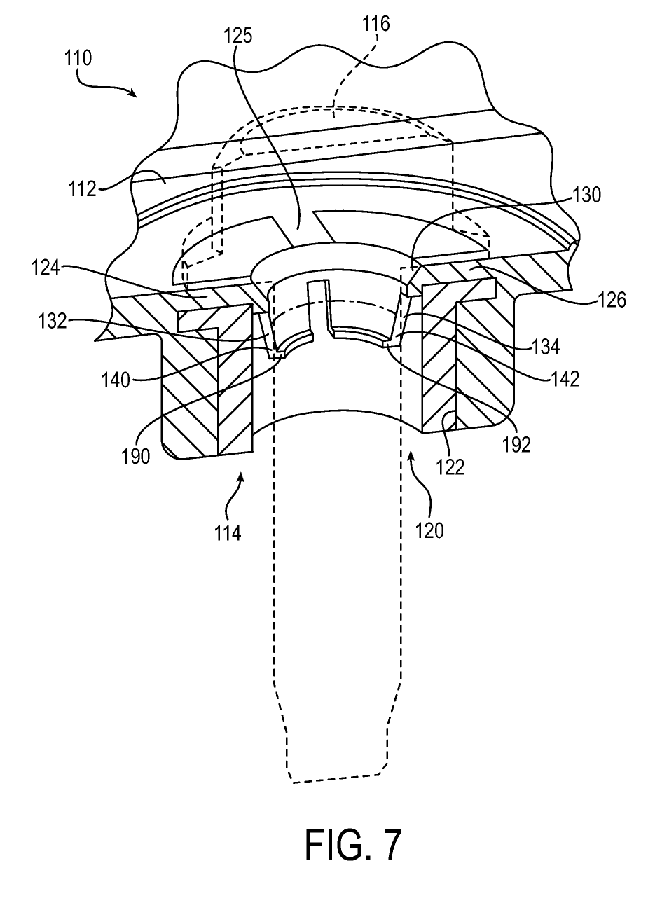

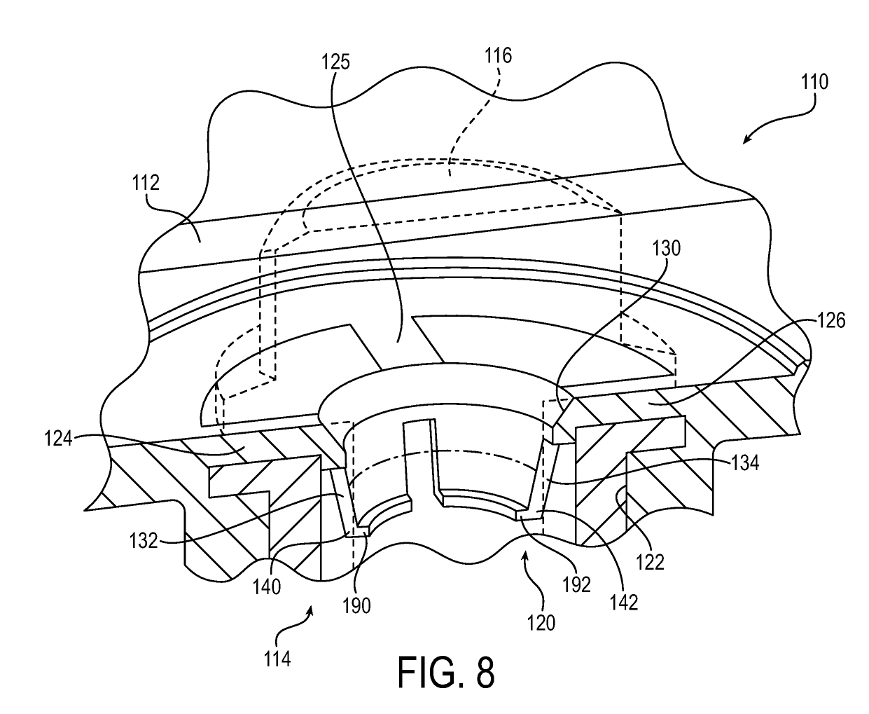

Turning now to FIGS. 7-8, another exemplary embodiment of the component assembly is shown at 110. The component assembly 110 is substantially the same as the above-referenced component assembly 10, and consequently the same reference numerals but indexed by 100 are used to denote structures corresponding to similar structures in the component assembly 110. In addition, the foregoing description of the component assembly 10 is equally applicable to the component assembly 110 except as noted below. Moreover, it will be appreciated upon reading and understanding the specification that aspects of the component assemblies may be substituted for one another or used in conjunction with one another where applicable.

The component assembly 110 includes a body 112 at least partially forming a plurality of fastener mounting features 114 and a fastener 116 for each fastener mounting feature 114. In an embodiment, only one fastener mounting feature is formed.

Each fastener mounting feature 114 includes a through aperture 120 defined by an interior surface 122 of the body 112 for receiving the shank of the fastener 116 along a longitudinal axis A, radially inwardly extending anchor portions 124-127, a base portion 130 and at least one resilient finger 132, 134 projecting radially and axially into the aperture 120.

A feature of the embodiment shown in FIGS. 7-8 is a radially inward extending portion 190, 192 included with each resilient finger 132, 134. The radially inward extending portions 190 and 192 allow greater gripping force to be applied to the shank of the fastener by increasing flexing of each respective resilient finger 132, 134 when the fastener 116 is inserted into the aperture 120. The thickness of the radially inward extending portions 190 and 192 may be about 75% the thickness of each respective resilient finger 132, 134. In an embodiment, the thickness of at least one of the radially inward extending portions is greater than 75% the thickness of the respective resilient finger. In another embodiment, the thickness of at least one of the radially inward extending portions is less than 75% the thickness of the respective resilient finger. The length of the radially inward extending portions 190 and 192 is preferably 5%-25%, more preferably 10%-15%, the length of each respective resilient finger 132, 134. Each radially inward extending portion 190, 192 allows a gripping force to be concentrated on a particular area of the shank, such as a threaded portion for enhancing retention of the fastener 116. In an embodiment, at least one of the radially inward extending portions 190, 192 deforms to engage threads on the shank.

Each radially inward extending portion 190, 192 circumferentially spans a respective free end 140, 142 of each respective resilient finger 132, 134. Circumferentially spanning each free end 140, 142 allows equalizing the gripping force applied to the fastener 116 to better secure and align the fastener 116. In an embodiment, at least one of the free ends does not include a radially inward extending portion. In another embodiment, at least one of the free ends includes more than one radially inward extending portions.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An assembly component including:
a body having a through aperture defined by an interior surface of the body for receiving the shank of a fastener; and
at least one resilient finger projecting radially and axially into the aperture for engaging at a free end of the at least one finger the shank of the fastener, and wherein the free end is radially inwardly spaced from the interior surface for defining therebetween a radial gap that allows the free end to flex toward the interior surface for gripping and retaining the shank of the fastener in the aperture.

2. The assembly component of claim 1, wherein the body includes a main body portion formed of plastic and a compression limiter fixed in the body and forming the interior surface, the compression limiter being formed of a material less compressible than main body portion in a region proximate to the compression limiter.

3. The assembly component of claim 2, where the main body portion is over-molded onto the compression limiter.

4. The assembly component of claim 3, wherein the body includes radially inwardly extending anchor portions connected to a base portion of the body,
wherein the free end is opposite a proximal end connected to the base portion of the body, and
wherein the compression limiter has a channel in which a fixed portion of each radially inwardly extending anchor portion is accommodated.

5. The assembly component of claim 4, wherein each finger is unitary with the main body portion.

6. The assembly component of claim 4, wherein the base portion is unitary with each finger.

7. The assembly component of claim 1, wherein each finger projects radially and axially into the aperture in an unflexed state of the finger.

8. The assembly component of claim 1, wherein the at least one finger is a plurality of fingers that are circumferentially spaced about the aperture.

9. The assembly component of claim 1, wherein the thickness of each finger is less than a length of each finger, respectively.

10. The assembly component of claim 1, wherein a circumferential length of each finger is greater than the thickness of each finger.

11. The assembly component of claim 1, wherein the thickness of each finger is preferably 5%-25%, most preferably 10%-15%, the length of each finger, respectively.

12. The assembly component of claim 1, further including a circumferential spacing between each finger.

13. The assembly component of claim 12, wherein the circumferential length of each finger is equal to or greater than a circumferential length of each circumferential spacing.

14. A component assembly including the assembly component of claim 1, further including:
the shank of the fastener held within the aperture.

15. A method of securing a fastener to a body of an assembly component of claim 1, including:
inserting a fastener into the aperture; and
the free end of each finger being resiliently flexed radially and axially to apply a gripping force to the shank of the fastener.

16. The assembly component of claim 1, wherein the compression limiter includes at least one channel, and preferably a plurality of channels, for connecting to each finger of the body.

17. The assembly component of claim 1, wherein the at least one resilient finger includes a radially inward extending portion.

18. The assembly component of claim 1, wherein the radially inward extending portion circumferentially spans the free end of the finger.
